(19) United States
(12) Patent Application Publication
(10) Pub. No.: US 2008/0002541 A1
(43) Pub. Date: Jan. 3, 2008

(54) RECORDING APPARATUS AND RECORD LEARNING METHOD

(75) Inventors: Hiroaki MORINO, Yokohama-shi (JP); Koichi Otake, Yokohama-shi (JP); Yukiyasu Tatsuzawa, Yokohama-shi (JP); Hiroyuki Moro, Fussa-shi (JP); Takahiro Nango, Oume-shi (JP); You Yoshioka, Taito-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/766,398

(22) Filed: Jun. 21, 2007

(30) Foreign Application Priority Data
Jun. 28, 2006 (JP) 2006-178567

(51) Int. Cl. G11B 5/09

(52) U.S. Cl. 369/47.19

(57) ABSTRACT

There is provided a recording apparatus which modulates record data by a predetermined modulation method and records record patterns corresponding to the record data on an optical disk, including a random data generator which generates random data as the record data, a data exchange processor which performs exchange processing on the random data so as to equalize a frequency of appearance of each of the record patterns relative to the entire record patterns on the optical disk corresponding to the respective random data, a modulator which modulates the random data subjected to the exchange processing by the predetermined modulation method, an optical head which records record patterns corresponding to the modulated random data on the optical disk, and reproduces the modulated random data from the recorded record patterns, and a record learning unit which calculates correction amounts for recorded positions of the respective record patterns based on the reproduced random data.

### CROSS-REFERENCE TO RELATED APPLICATIONS

This application is based upon and claims the benefit of priority from the prior Japanese Patent Application No. 2006-178567, filed on Jun. 28, 2006; the entire contents of which are incorporated herein by reference.

### BACKGROUND OF THE INVENTION

1. Field of the Invention

The present invention relates to a recording (reproducing) apparatus for an optical disk or the like for example and a record learning method, and more specifically relates to a recording/reproducing apparatus and a record learning method for performing record learning for recording with an optimum recording condition.

2. Description of the Related Art

In an optical disk recording/reproducing apparatus, a laser light or the like is irradiated on an optical disk so as to record a record signal thereon, and a reproduction signal is obtained using a reflected light of a laser light irradiated on the optical disk. Writing (recording) on the optical disk is performed using a combination of a written mark having a predetermined length and a space having a predetermined length between marks.

In the optical disk recording/reproducing apparatus, before performing recording, a so-called record learning is performed with respect to several adjustment parameters for position adjustment of marks to be recorded, adjustment of laser power, tilt adjustment of an optical head, and the like, so that recording by an optimum condition can be achieved. The record learning is mainly intended for prevention in advance of deviation of the position of a recorded mark (positions of a mark and a space) from a proper position, and is an important process step for preventing a reading error. Record learning on an optical disk is described in, for example, JP-A 2002-319130 (KOKAI). In record learning for an optical disk, it is required to adjust all possible patterns of mark and space, and therefore adjustment of an optical head is performed generally by recording/reproducing a random signal thereon.

Incidentally, it is known that, depending on an optical disk recording modulation method, there may be a case that all patterns do not appear evenly even when using a random signal for patterns of mark and space to be recorded. For example, when ETM (8 to 12 modulation) is used as a modulation method, all patterns of mark and space do not appear evenly even when record learning is performed using a random signal, and thus learning values may not converge but disperse due to a pattern having a low frequency of appearance, a long time may be taken for record learning, or a failure may occur.

### SUMMARY OF THE INVENTION

As above, conventional optical disk recording (reproducing) apparatuses and record learning methods have problems such as taking a long time for record learning, failing the record learning, and the like. The present invention is made to solve such problems, and an object thereof is to provide a recording/reproducing apparatus and a record learning method which enable efficient record learning in a short period of time.

To achieve the above-stated objects, a recording apparatus according to a first aspect of the present invention is a recording apparatus for modulating record data by a predetermined modulation method and recording record patterns corresponding to the record data on an optical disk, including: a random data generator which generates random data as the record data; a data exchange processor which performs exchange processing on the random data so as to equalize a frequency of appearance of each of the record patterns relative to the entire record patterns on the optical disk corresponding to the respective random data; a modulator which modulates the random data subjected to the exchange processing by the predetermined modulation method; an optical head which records record patterns corresponding to the modulated random data on the optical disk, and reproduces the modulated random data from the recorded record patterns; and a record learning unit which calculates correction amounts for recorded positions of the respective record patterns based on the reproduced random data.

A record learning method according to a second aspect of the present invention is a record learning method for a recording apparatus which modulates record data by a predetermined modulation method and records record patterns corresponding to the record data on an optical disk, including: generating random data as the record data; performing exchange processing on the random data so as to equalize a frequency of appearance of each of the record patterns relative to the entire record patterns on the optical disk corresponding to the respective random data; modulating the random data subjected to the exchange processing by the predetermined modulation method; recording the record patterns corresponding to the modulated random data on the optical disk; reproducing the modulated random data from the recorded record patterns; and calculating correction amounts for recorded positions of the respective record patterns based on the reproduced random data.

### BRIEF DESCRIPTION OF THE DRAWINGS

FIG. 1 is a view showing a relationship between laser power and marks in an optical disk recording/reproducing apparatus.

FIG. 2 is a view showing how displacement of marks occurs in the optical disk recording/reproducing apparatus.

FIG. 3 is a view showing an overview of frequencies of appearance of marks and spaces in record learning in the optical disk recording/reproducing apparatus.

FIG. 4 is a block diagram showing the structure of a recording/reproducing apparatus of a first embodiment of the present invention.

FIG. 5 is a flowchart showing a recording operation of the recording/reproducing apparatus of the first embodiment.

FIG. 6 is a view showing an example of a data frame in the recording/reproducing apparatus of the first embodiment.

FIG. 7 is a view showing an example of a data block in the recording/reproducing apparatus of the first embodiment.

FIG. 8 is a view showing an example of a scrambled data block in the recording/reproducing apparatus of the first embodiment.

FIG. 9 is a flowchart showing a reproducing operation in the recording/reproducing apparatus of the first embodiment.

FIG. 10 is a block diagram showing the structure of a recording/reproducing apparatus of a second embodiment of the present invention.

FIG. 11 is a flowchart showing a record learning operation of the recording/reproducing apparatus of the second embodiment.

### DESCRIPTION OF THE EMBODIMENTS

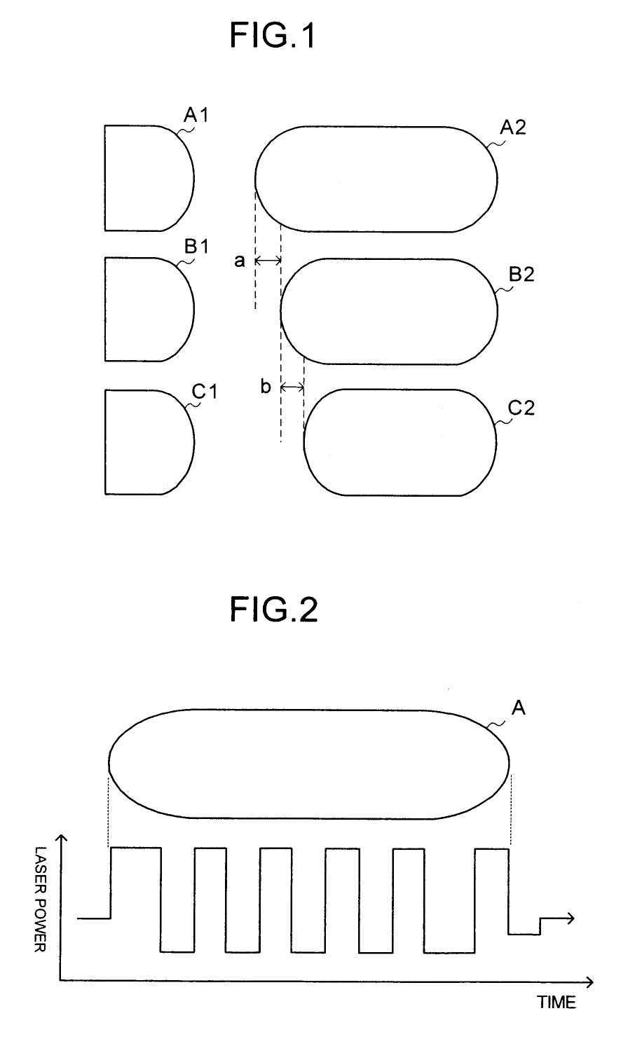

First, with reference to FIG. 1 to FIG. 3, record learning of a recording/reproducing apparatus according to an embodiment of the present invention will be explained. In positional adjustment for marks to be recorded in the record learning in the recording/reproducing apparatus, positional adjustment of marks are performed by actually writing certain record data on an optical disk and reading positions of written marks and spaces.

Here, when writing a mark is performed using irradiation of a laser light with only a single pulse, it is possible that widths of marks become uneven due to the degree of thermal transmission on the optical disk, or that the first one and the last one of marks are shifted. For example, as shown in FIG. 1, assuming that ideal mark positions and spaces are B1 and B2, the writing with a single pulse may provide marks A1 and A2 which are shifted forward by a length a, or marks C1 and C2 which are shifted backward by a length b. Accordingly, in the optical disk recording/reproducing apparatus, a multi-pulse having a pulse width being adjusted is used to irradiate a laser light so that even marks are recorded. FIG. 2 shows how a mark A is recorded by a multi-pulse.

In an optical disk such as DVD or HD-DVD, a plurality of combinations are used for the length of a mark to be written and the length of a space before a mark, and multi-pulses which are different according to combinations of marks and spaces having various lengths respectively are used. Therefore, it is needed to adjust each of multi-pulse waveforms for each of combinations of mark and space. In record learning, waveform adjustment for a relevant multi-pulse is performed by actually performing recording/reproducing processing.

Taking an example of an optical disk of HD DVD-R format, in ETM (8 to 12 modulation) used in HD DVD-R, when the length of a recorded mark as a reference is denoted by T, there exist 2T to 13T marks. Among them, when marks and spaces are categorized respectively in four types: 2T, 3T, 4T, and 5T or longer, there are four types of marks and four types of spaces, and when combining two types of relationships before and after marks and spaces, the marks and spaces can be categorized in 32 types of combinations in total. Specifically, in the mark position adjustment of an optical disk recording/reproducing apparatus of the HD DVD-R method, multi-pulse positions of respective marks are adjusted so that the entire combinations of the 32 types are at desired edge positions.

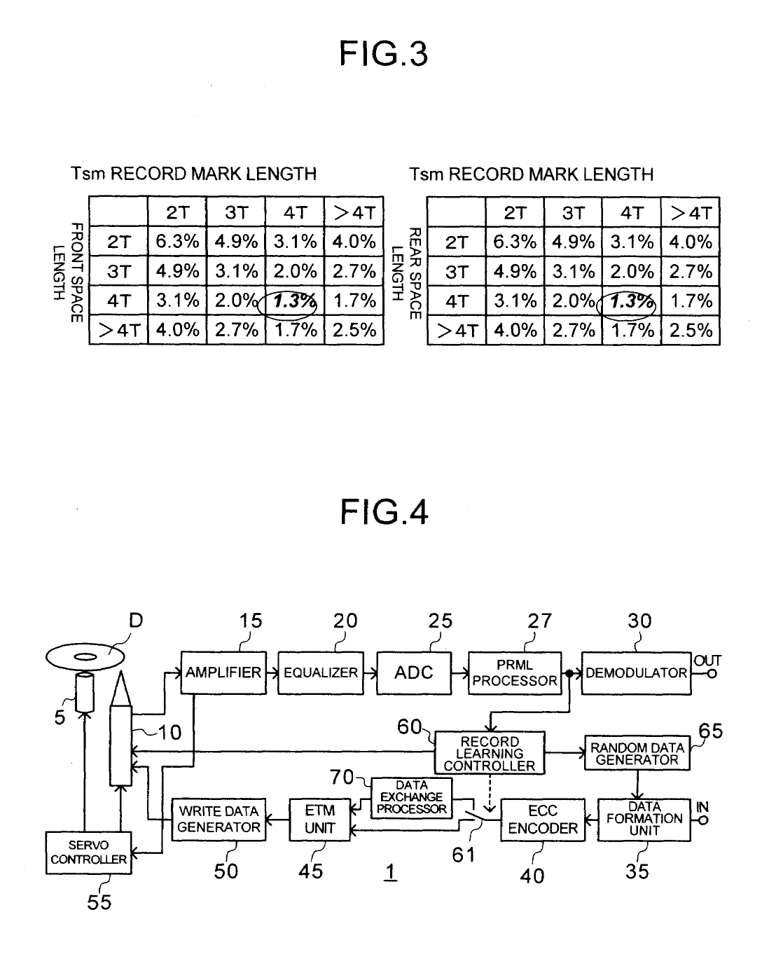

In the record learning in general, record data for record learning which are obtained by modulating random data by ETM are used. Shown in FIG. 3 are measurement results from measuring frequencies of appearance of the 32 types of patterns of mark and space in the case where such record data for record learning are used, and are values in which the total of 32 patterns is 100%. Note that in FIG. 3, an edge occurrence frequency per 1 chbit is 0.28 [times/chbit]. As shown in FIG. 3, the frequency of appearance of a pattern of 4T space/4T mark and the frequency of appearance of a pattern of 4T mark/4T space are both 1.3%, which are lower compared to other patterns.

In this way, when there is dispersion in frequencies of appearance of the respective patterns of mark and space in record learning, in particular when there is a pattern having a significantly low frequency of appearance, it causes data collection for record learning to take long time. Further, this 4T4T pattern exists in a converged way in a synchronization signal VFO in the beginning of each data block, which will be described later. Accordingly, if this synchronization signal VFO area is not readable due to a scratch or the like, the data collection takes longer time and further the record learning may disperse depending on the circumstances.

In an embodiment of the present invention explained below, in record patterns of mark and space using random data, the frequency of appearance of each record pattern with respect to the entire record patterns is equalized. Specifically, with respect to a pattern of mark and space having a low frequency of appearance even by using the random data, processing is performed on original data before modulation so as to increase the frequency of appearance of this pattern, thereby equalizing the frequency of appearance.

Hereinafter, an embodiment of the present invention will be described in detail with respect to the drawings. FIG. 4 is a block diagram showing the structure of a recording/reproducing apparatus of a first embodiment according to the present invention. As shown in FIG. 4, the recording/reproducing apparatus 1 of this embodiment includes a disk drive 5, an optical head 10, an amplifier 15, an equalizer 20, an ADC 25, a PRML (Partial Response Maximum Likelihood) processor 27, a demodulator 30, a data formation unit 35, an ECC encoder 40, an ETM unit 45, a write data generator 50, a servo controller 55, a record learning controller 60, a switch 61, a random data generator 65 and a data exchange processor 70. Hereinafter, the recording/reproducing apparatus 1 is explained as one that records on and reproduces an optical disk D.

The disk drive 5 is a drive mechanism to rotate the optical disk D in a predetermined direction, and has a spindle motor or the like for example. The optical head 10 is a light pickup device which records record data as a combination (record pattern) of a mark having a predetermined length and a space having a predetermined length by irradiating a laser light on the optical disk D, and reads record patterns recorded in the optical disk D by similarly irradiating a laser light thereon. The optical head 10 has functions to perform writing processing of record patterns on the optical disk D based on a record signal received from the write data generator 50, and to convert read record pattern into an electronic signal (reproduction signal) and sends the electronic signal to the amplifier 15. The optical head 10 also has a function to adjust (correct) a generated record signal when the recording/reproducing apparatus 1 performs record learning.

The amplifier 15 is a preamplifier which amplifies the reproduction signal received from the optical head 10 to a predetermined level. The equalizer 20 is a waveform equalizer which removes waveform distortion, noise, and the like included in the reproduction signal amplified by the amplifier 15, thereby trimming the waveform of the reproduction signal. The reproduction signal with a waveform being trimmed by the equalizer 20 is inputted to the ADC 25. The ADC 25 is an analog/digital converter which converts an analog reproduction signal received from the equalizer 20 into a digital reproduction signal. The digital reproduction signal converted by the ADC 25 is inputted to the demodulator 30 via the PRML processor 27. The PRML processor (Partial Response Maximum Likelihood processor) 27 is a signal processor which calculates from an actual signal a signal which is most likely to exist as an actual reproduction signal and performs waveform trimming thereon. The demodulator 30 demodulates and converts an inputted digital reproduction signal into original digital data (digital bit column).

The data formation unit 35 is a data formation processor which adds a code group including a data ID as an identification code of data, an ID error detection code (IED) for performing error identification of data ID, a reserved code (RSV), an error detection code (EDC), and the like to digital data (digital bit column, hereinafter referred to as “main data” in some cases) to be recorded, thereby forming a data frame. The data formation unit 35 has a function to add this code group to the beginning and/or end of main data having a predetermined number of bits to form a data frame having predetermined rows and columns.

The ECC encoder 40 adds parity codes to record data formed as a data frame by the data formation unit 35, thereby performing ECC encode processing on the record data. The ECC encoder 40 has a function to add two types of parity codes to a data frame to scramble the data frame, thereby performing encode processing on the data frame.

The ETM unit 45 is a so-called 8 to 12 modulator (eight-twelve modulation), and has a function to convert each 8 bits of record data into data of 12 bits.

The write data generator 50 is a signal conversion processor which converts record data modulated by ETM into a signal in a format for optical recording to thereby generate write data (record signal). The write data generator 50 converts the record data modulated by the ETM unit 45 into a record signal for optical writing.

The servo controller 55 is a drive controller which controls driving of the disk drive 5 and the optical head 10. The servo controller 55 has a function to perform control of rotation speed of the optical disk D by the disk drive 5, movement control, tilt control, and the like for the optical head 10, and the like based on the reproduction signal received from the amplifier 15.

The record learning controller 60 is a recording control processor which executes record learning processing for correcting a positional relationship of marks and spaces constituting a record pattern prior to recording of the record pattern on the optical disk D. The record learning controller 60 has a function to instruct generation of random data to the random data generator 65 when performing record learning, and input record data encoded by the ECC encoder 40 to the data exchange processor 70 which will be described later. Further, the record learning controller 60 also has a function to retrieve reproduction data reproduced by the record learning processing from an output of the PRML processor 27, and calculate a correction amount of a positional relationship of mark and space to be recorded and send the correction amount to the optical head 10. The switch 61 switches the output of the ECC encoder 40 to the data exchange processor 70 based on the instruction from the record learning controller 60.

The random data generator 65 is a data generation processor which generates random data as record data for record learning based on the instruction from the record learning controller 60 and inputs the random data to the data formation unit 35. Further, the data exchange processor 70 is a data processor which converts data (data bit) at a predetermined position in a data block received from the ECC encoder 40 via the switch 61. When the random data is recorded on the optical disk D via the data formation unit 35, the ECC encoder 40, the ETM unit 45, and the write data generator 50, the data exchange processor 70 operates to select a data bit which generates a combination of mark and space having a low frequency of appearance and perform data exchange processing thereon to increase the frequency of appearance of the mark and the space. Thus, the frequency of appearance of record data is equalized.

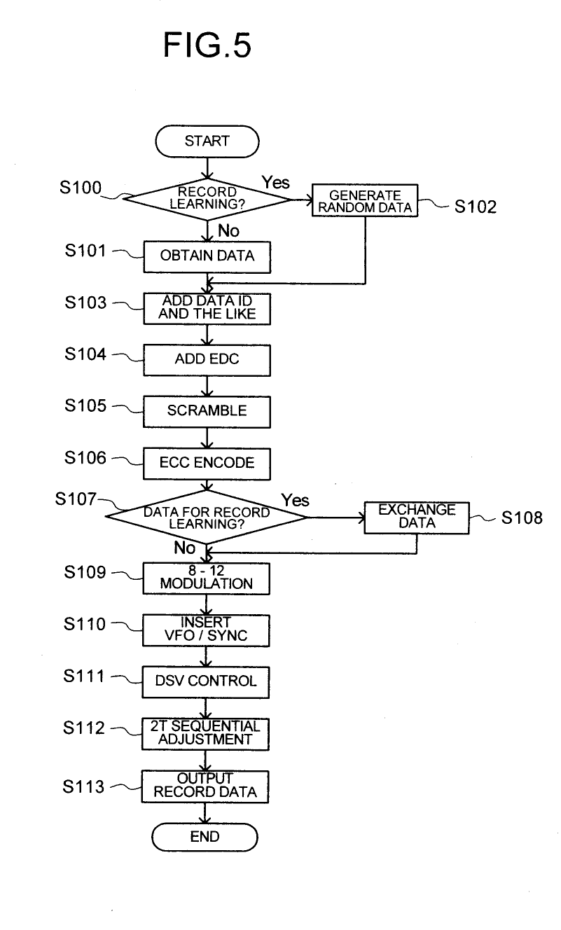

Next, with reference to FIG. 5 to FIG. 8, a recording operation of the recording/reproducing apparatus 1 of this embodiment will be described.

The record learning controller 60 judges whether recording processing is normal recording processing or recording processing of record learning (S100). When the recording processing is the normal recording processing (No in S100), the record learning controller 60 sets the switch 61 so that the ECC encoder 40 and the ETM unit 45 are connected with each other directly, and the data formation unit 35 prepares for accepting digital data (main data) inputted to an input terminal IN.

When the recording processing is the recording processing of record learning (Yes in S100), the record learning controller 60 sets the switch 61 so that the ECC encoder 40 and the data exchange processor 70 are connected with each other, and instructs the random data generator 65 to generate random data. The random data generator 65 generates random data (S102). The data formation unit 35 accepts the random data generated by the random data generator 65 instead of the data inputted to the input terminal IN.

When digital data from the input terminal IN or digital data from the random data generator 65 are inputted, the data formation unit 35 adds a code group including a 4 byte data ID, a 2 byte IED and a 6 byte RSV in this order to the beginning of 2 kilobyte main data (S103).

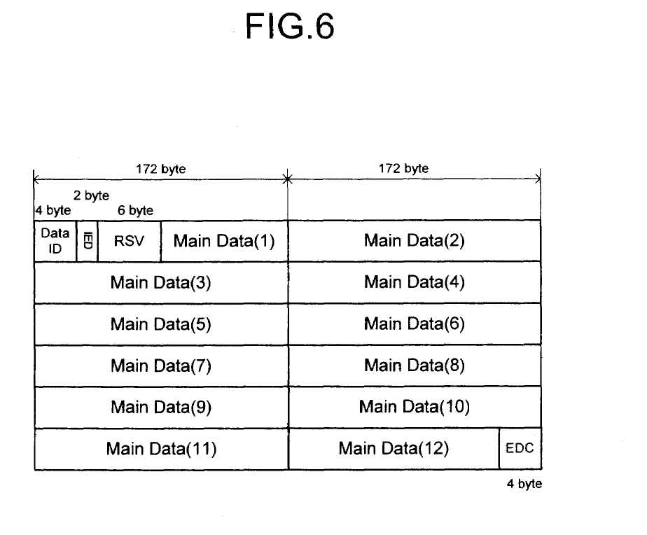

When the code group is added to the beginning of the main data, the data formation unit 35 adds a 4 byte EDC to the end of the main data (S104). The data formation unit 35 partitions record data to which addition of this code group is completed by every 172 bytes to compose a data frame having 2 columns and 6 rows shown in FIG. 6. As shown in FIG. 6, digital data columns constituted of data ID, IED, RSV, main data (1) to (12) and EDC in this order compose a data frame of 2 columns and 6 rows partitioned by 172 bytes. The data formation unit 35 composes a data block by connecting 32 rows of data frames and sends the data block to the ECC encoder 40.

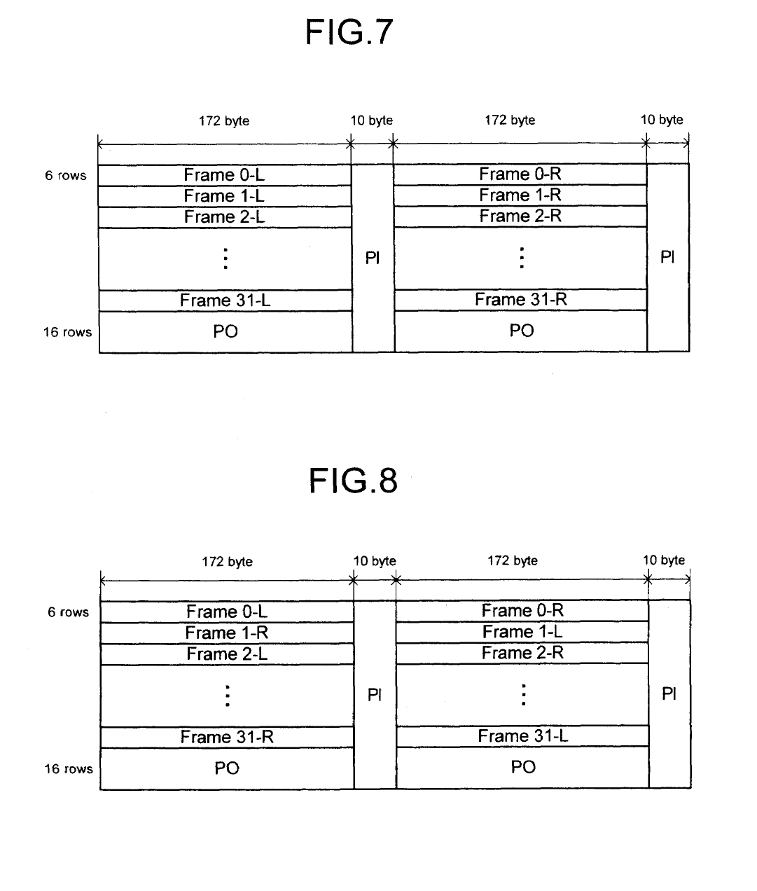

When the data block in which 32 rows of data frames are connected is formed, the ECC encoder 40 adds a parity code group PO to a 33rd row following a 32nd data frame, as shown in FIG. 7. Further, the ECC encoder 40 adds a parity code PI to the end of each of the 172 byte data frame columns. When the parity code groups PO and PI are added, the ECC encoder 40 exchanges frames of odd rows in the first column (frames 1-L, 3-L, . . . 31L in FIG. 7) with frames in the second column (similarly, frames 1-R, 3-R, . . . 31R) in the data block to scramble these frames (S105). FIG. 8 shows a data block scrambled by such a procedure.

When the data block is scrambled, the ECC encoder 40 ECC encode processes data constituting the data block in a predetermined order (S106).

In the case of the normal recording processing (No in S107), the ECC encoder 40 sends the ECC encoded data constituting the data block to the ETM unit 45.

In the case of the record learning processing (Yes in S107), the ECC encoder 40 sends the encoded data constituting the data block to the data exchange processor 70 via the switch 61. The data exchange processor 70 performs conversion processing to exchange an arbitrary code with predetermined data so that a combination having a low frequency of appearance of mark and space proactively appears in the received data block (S108). Taking the above-described case in which frequencies of appearance of a mark and a space having a length of 4T respectively is low as an example, the data exchange processor 70 exchanges arbitrary data with hexadecimal data “7Eh” which causes to generate 4T4T mark and space. Accordingly, it is possible to increase the frequencies of appearance of the 4T mark and the 4T space. More specifically, for example, data to be converted into 2T data having a relatively high frequency of appearance can be extracted and exchanged with “7Eh”. Further, by exchanging all the parities PO and PI as error correction codes with “7Eh”, the frequency of appearance of the 4T4T mark and space can be increased. When such a conversion processing is performed, the data exchange processor 70 sends data of the data block to the ETM unit 45.

The ETM unit 45 encodes the received data in the data block by ETM and sends the data to the write data generator 50 (S109).

The write data generator 50 adds a VFO code to the beginning of the received data and adds a synchronization code to the end thereof, thereby generating write data (S110).

Next, on the write data, the write data generator 50 performs DSV processing for making the DC level of the write data close to zero (S111) and 2T sequential adjustment processing for making adjustment such that a code which becomes 2T that is the double of a unit T of a mark to be recorded is not repeated sequentially (S112).

When the DSV processing and/or the 2T sequential adjustment processing are completed, the write data generator 50 outputs the write data to the optical head 10 (S113) as the record signal. The optical head 10 performs writing processing on the optical disk D based on the received record signal.

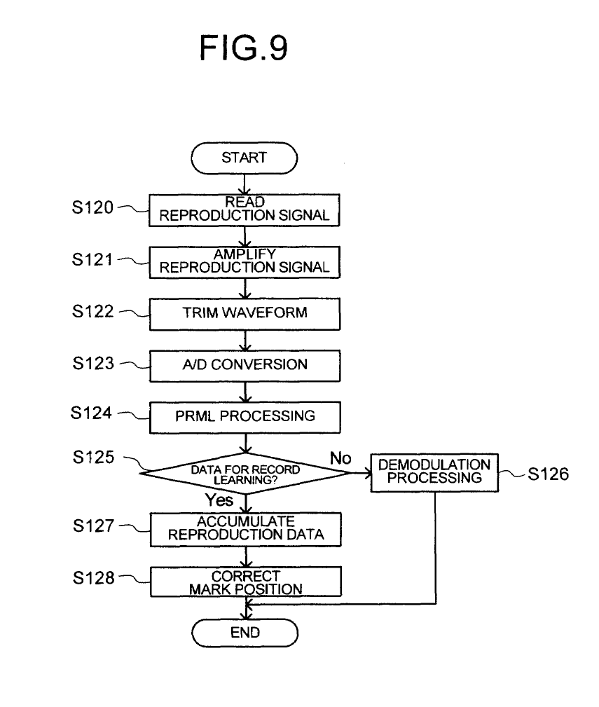

Next, with reference to FIG. 9, a reproduction operation of the recording/reproducing apparatus 1 of this embodiment will be explained.

The optical head 10 reads the recorded data as a reproduction signal (S120). The optical head 10 sends the read reproduction signal to the amplifier 15.

The amplifier 15 amplifies the passed reproduction signal to a predetermined level (S121). The amplifier 15 sends the amplified reproduction signal to the equalizer 20.

The equalizer 20 removes waveform distortion and noise included in the received reproduction signal to trim the waveform of the reproduction signal (S122). The equalizer 20 sends the trimmed reproduction signal to the ADC 25.

The ADC 25 converts the received analog reproduction signal into a digital reproduction signal and inputs this signal to the PRML processor 27 (S123). The PRML processor 27 calculates from an actual inputted signal a signal which is most likely to exist as an actual reproduction signal and performs waveform trimming thereon (S124). Thereafter, the signal is inputted to the demodulator 30.

When the reproduction signal is normal data, in other words, not random data (No in S125), the PRML processor 27 sends the signal to the demodulator 30. The demodulator 30 demodulates the signal thereafter inputs to a digital processing unit (not shown) in a later stage via the output terminal OUT (S126).

When the reproduction signal is data for record learning, in other words, random data (Yes in S125), the PRML processor 27 inputs the reproduction signal to the record learning controller 60. The record learning controller 60 accumulates the received reproduction signal (S127), and detects displacement from a proper position for each of patterns of mark and space, thereby determining correction amount information. The record learning controller 60 inputs the determined correction amount information to the optical head 10.

The optical head 10 performs correction processing on respective multi-pulse signals corresponding to the respective patterns of mark and space based on the received correction amount information (S128). Thereafter, the recording processing of the record learning and the reproducing processing are repeated, thereby performing a pre-recording adjustment.

Thus, according to the recording/reproducing apparatus of this embodiment, for data before modulation, original data before modulation corresponding to a mark and a space having a low frequency of appearance among marks and spaces to be recorded on an optical disk is subjected to exchange processing, and thus marks and spaces having uniform frequencies of appearance can be recorded. Accordingly, efficient record learning can be performed, and a situation such that the record learning cannot be performed due to dispersion can be avoided.

Note that in the above-described embodiment, the case of having the ETM unit 45 is explained, but the embodiment is not limited to this case and is applicable to a case of having a modulator using a different modulation method. In this case, the random data is demodulated by the different modulation method, combinations of respective patterns of mark and space of the modulated data are measured, and thereby the appearance proportion of each pattern with respect to the entire patterns is calculated. Then, original data before modulation which generates a pattern of mark and space having the lowest appearance proportion (“7Eh” in the above first embodiment) may be exchanged with a predetermined data before modulation.

Further, as a method of judging a mark and a space that should be increased in frequency of appearance, other than selecting a pattern having a lowest frequency of appearance, a method of selecting all patterns which is lower than a certain appearance proportion (fixed threshold) or a method of selecting all patterns which are apart from a distribution of entire appearance proportions by a certain value or larger are possible. More specifically, when the appearance proportion of a certain pattern is half or lower than an average appearance proportion in the case where all marks and spaces appear evenly (when being lower than 1.5% in the example shown in FIG. 3, since there are 32 patterns in total and hence the average appearance proportion is 3.125%), the exchange processing can be carried out so that the aforementioned pattern appears more frequently.

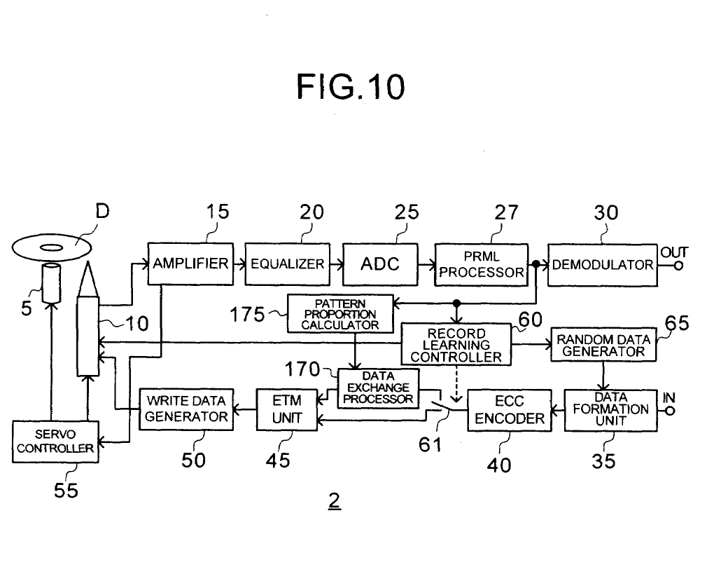

Next, another embodiment of the present invention will be explained in detail. FIG. 10 is a block diagram showing the structure of a recording/reproducing apparatus of a second embodiment according to the present invention. As shown in FIG. 10, the recording/reproducing apparatus 2 of this embodiment is the recording/reproducing apparatus 1 of the first embodiment shown in FIG. 4 which further includes a pattern proportion calculator 175. Accordingly, components in common with the recording/reproducing apparatus 1 of the first embodiment are shown by attaching common numerals, and duplicating explanations are omitted. As shown in FIG. 10, the recording/reproducing apparatus 2 of this embodiment includes a disk drive 5, an optical head 10, an amplifier 15, an equalizer 20, an ADC 25, a PRML processor 27, a demodulator 30, a data formation unit 35, an ECC encoder 40, an ETM unit 45, a write data generator 50, a servo controller 55, a record learning controller 60, a switch 61, a random data generator 65, a data exchange processor 170 and a pattern proportion calculator 175.

The data exchange processor 170 is a data processor which converts data bit at a predetermined position in a data block received from the ECC encoder 40. When the random data is recorded on the optical disk D via the data formation unit 35, the ECC encoder 40, the ETM unit 45, and the write data generator 50, the data exchange processor 170 operates to select a data bit which generates a combination of mark and space having a low frequency of appearance and perform control so as to increase the frequency of appearance of the mark and the space. The data exchange processor 70 of the first embodiment itself retains data bits which generate a combination of mark and space having a low frequency of appearance, but the data exchange processor 170 in the second embodiment is different in that the data bits are selected based on exchange data information received from the pattern proportion calculator 175, which will be described later.

The pattern proportion calculator 175 is a wave form detector which calculates the frequency of appearance of each pattern of mark and space based on a digital signal obtained by the optical head 10, the amplifier 15, the equalizer 20, the ADC 25 and the PRML processor 27. The pattern proportion calculator 175 has a function to judge, as described above, a pattern having a lowest frequency of appearance, all patterns which is lower than a certain appearance proportion (fixed threshold), all patterns which are apart from a distribution of entire appearance proportions by a certain value or larger, and the like as “pattern of mark and space which should be increased in frequency of appearance”, and sends corresponding original data before modulation to the data exchange processor 170 as the exchange data information.

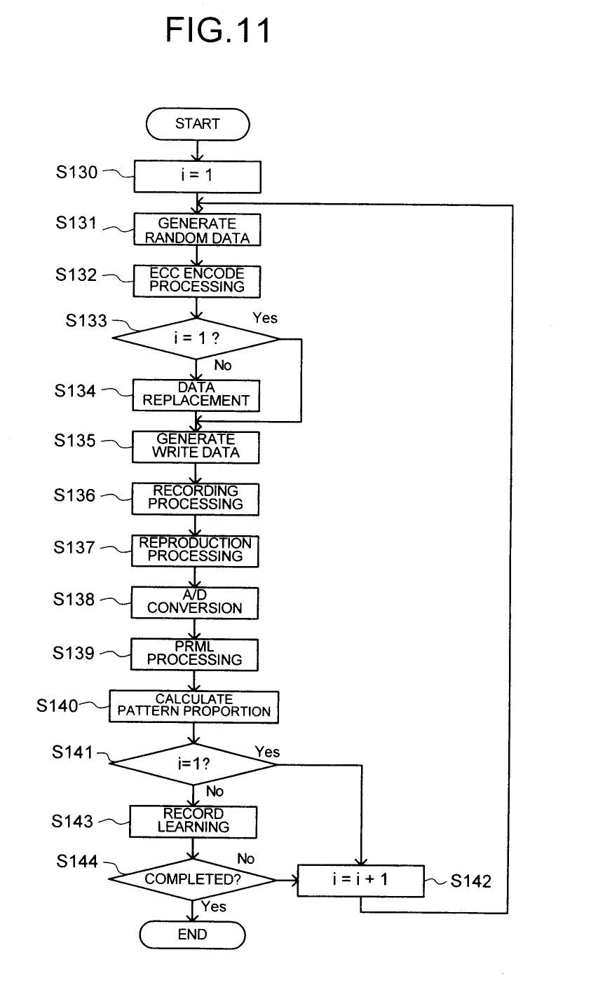

Here, with reference to FIG. 10 and FIG. 11, an example of a record learning operation of the recording/reproducing apparatus 2 of this embodiment, namely, performing a recording operation and a reproducing operation at once will be explained.

The record learning controller 60 sets the initial value of a variable i showing the number of times of recording and reproducing (number of times of record learning) to 1 (S130). Then, the record learning controller 60 instructs the random data generator 65 to generate random data. Upon reception of an instruction from the record learning controller 60, the random data generator 65 generates random data and inputs the random data to the data formation unit 35 (S131).

Similarly to the first embodiment, the data formation unit 35 adds an aforementioned code group including data ID, IED and RSV and an EDC to the random data as main data. Further, the data formation unit 35 forms a data frame from record data to which addition of the code group is completed, and further connects 32 rows of data frames to form a data block and sends the data block to the ECC encoder 40. The ECC encoder 40 adds parity code groups PO and PI thereto and performs scrambling and ECC encode processing thereon (S132). An operation up to this point is in common with Step 103 to Step 106 shown in FIG. 5.

The record learning controller 60 determines the number of times of record learning (S133). At this point, since writing is not performed and the variable i is “1”, the record learning controller 60 does not control the switch 61 (Yes in S133). As a result, the ECC encoded data is sent to the ETM unit 45. The ETM unit 45 modulates data constituting the received data block by ETM and sends the modulated data to the write data generator 50, and the write data generator 50 adds a VFO code to the beginning of the received data and adds a synchronization code to the end thereof, thereby generating write data. Then, the write data generator 50 performs DSV processing and 2T sequential adjustment processing on the write data and outputs the write data as a record signal to the optical head 10 (S135). The operation up to this point is in common with Step 109 to Step 113 shown in FIG. 5.

The optical head 10 performs write processing on the optical disk D based on the received record signal (S136).

The optical head 10 reads the recorded data as a reproduction signal (S137). The optical head 10 sends the read reproduction signal to the amplifier 15.

The amplifier 15 amplifies the received reproduction signal to a predetermined level and sends the signal to the equalizer 20. The equalizer 20 removes waveform distortion and noise included in the received reproduction signal to trim the waveform of the reproduction signal and sends the reproduction signal to the ADC 25. The ADC 25 converts the received analog reproduction signal into a digital reproduction signal and sends the digital reproduction signal to the PRML processor 27 (S138). The PRML processor 27 trims the waveform of the reproduction signal and inputs the reproduction signal to the pattern proportion calculator 175 (S139).

The pattern proportion calculator 175 detects frequencies of appearance of marks and spaces from the received digital reproduction signal, selects original data before modulation of a pattern which should be increased in frequency of appearance, and sends the data to the data exchange processor 170 as the exchange data information (S140).

The record learning controller 60 determines the number of times of record learning (S141). At this point, since writing with data conversion processing is not performed yet and the variable i is “1”, the record learning controller 60 does not input correction amount information to the optical head 10, counts up the variable i (S142), and instructs the random data generator 65 to generate random data (S131). Generated random data is sent to the data formation unit 35.

Similarly to the first embodiment, the data formation unit 35 adds an aforementioned code group including data ID, IED and RSV and an EDC to the random data as main data to form a data frame, forms a data block, and sends the data block to the ECC encoder 40. The ECC encoder 40 adds parity code groups PO and PI thereto and performs scrambling and ECC encode processing thereon (S132).

The record learning controller 60 determines the number of times of record learning (S133). At this point, since the variable i is “2”, the record learning controller 60 controls the switch 61 so that the data exchange processor 170 is connected to the ECC encoder 40 (No in S133). As a result, the ECC encoded data is sent to the data exchange processor 170.

The data exchange processor 170 performs conversion processing of exchanging an arbitrary code in the received data block based on exchange data information received from the pattern proportion calculator 175 so that a combination of mark and space having a low frequency of appearance appears proactively, and data after exchange is inputted to the ETM unit 45 (S134).

The ETM unit 45 modulates data constituting the received data block by ETM and sends the modulated data to the write data generator 50, and the write data generator 50 adds a VFO code to the beginning of the received data and adds a synchronization code to the end thereof, thereby generating write data. Then, the write data generator 50 performs DSV processing and 2T sequential adjustment processing on the write data and outputs the write data as a record signal to the optical head 10 (S135).

The optical head 10 performs write processing on the optical disk D based on the received record signal (S136).

The optical head 10 reads the recorded data as a reproduction signal (S137). The optical head 10 sends the read reproduction signal to the amplifier 15.

The amplifier 15 amplifies the received reproduction signal to a predetermined level and sends the signal to the equalizer 20. The equalizer 20 removes waveform distortion and noise included in the received reproduction signal to trim the waveform of the reproduction signal and sends the reproduction signal to the ADC 25. The ADC 25 converts the received analog reproduction signal into a digital reproduction signal (S138). The PRML processor 27 trims the waveform of the converted reproduction signal and inputs the reproduction signal to the demodulator 30 and the pattern proportion calculator 175 (S139).

The pattern proportion calculator 175 detects frequencies of appearance of marks and spaces from the received digital reproduction signal, selects original data before modulation of a pattern which should be increased in frequency of appearance, and sends the data to the data exchange processor 170 as the exchange data information (S140).

The record learning controller 60 determines the number of times of record learning (S141). At this point, since the variable i is still “2” (No in S141), the record learning controller 60 accumulates the reproduction data with a waveform being trimmed by the PRML processor 27, and detects displacement from a proper position for each pattern of mark and space, thereby generating a correction amount information. The record learning controller 60 inputs the generated correction amount information to the optical head 10 (S143). The optical head 10 adjusts the pulse width, amplitude, and so on of the multi-pulse based on the correction amount information.

The record learning controller 60 counts up the variable i (S142) when carrying on the record learning (No in S144), and instructs the random data generator 65 to generate random data (S131). Thereafter, similar steps are repeated.

With the recording/reproducing apparatus of this embodiment, increase in speed of record learning and preventing dispersion thereof can be realized. Particularly, since a frequency of appearance that should be increased is dynamically calculated, the recording/reproducing apparatus is applicable to the case where the modulation means is not the ETM and a frequency in appearance of each pattern of mark and space is unknown.

Thus, according to the embodiments of the present invention, by increasing a pattern of mark and space having a low frequency of appearance when the record learning data is created, dispersion in record learning due to insufficiency of obtained samples can be prevented. Further, by increasing a mark-space pattern having a low frequency of appearance, the time until obtaining a required number of samples is shortened, and thus the record learning time can be made shorter. Moreover, since random data is used as main data when performing record learning, the operation of a loop of the record learning can be stabilized.

It should be noted that the present invention is not limited to the above-described embodiments as they are, but may be embodied with components being modified in a range not departing from the contents thereof at the stage of implementation. Further, various inventions can be formed by appropriately combining a plurality of components disclosed in the above-described embodiments. For example, some of all the components shown in the embodiments may be deleted. Further, components ranging across different embodiments can be combined appropriately.

For example, the recording/reproducing apparatus is explained in the above-described embodiments, but there may be formed a recording apparatus dedicated for recording only.

What is claimed is:

1. A recording apparatus for modulating record data by a predetermined modulation method and recording record patterns corresponding to the record data on an optical disk, comprising:
a random data generator which generates random data as the record data;
a data exchange processor which performs exchange processing on the random data so as to equalize a frequency of appearance of each of the record patterns relative to the entire record patterns on the optical disk corresponding to the respective random data;
a modulator which modulates the random data subjected to the exchange processing by the modulation method;
an optical head which records record patterns corresponding to the modulated random data on the optical disk, and reproduces the modulated random data from the recorded record patterns; and
a record learning unit which calculates correction amounts for recorded positions of the respective record patterns based on the reproduced random data.

2. The recording apparatus as set forth in claim 1,
wherein said data exchange processor performs the exchange processing on the random data so as to increase the number of random data corresponding to a record pattern having a lowest frequency of appearance relative to the entire record patterns when the random data are modulated by the modulation method and record patterns corresponding to the random data are recorded on the optical disk.

3. The recording apparatus as set forth in claim 1,
wherein said data exchange processor performs the exchange processing on the random data so as to increase the number of random data corresponding to respective record patterns each having a frequency of appearance equal to or lower than a predetermined threshold value relative to the entire record patterns when the random data are modulated by the modulation method and record patterns corresponding to the random data are recorded on the optical disk.

4. The recording apparatus as set forth in claim 1,
wherein said optical head corrects recorded positions of the record patterns on the optical disk based on the correction amount.

5. The recording apparatus as set forth in claim 1,
wherein said modulator modulates the random data by a modulation method of eight to twelve modulation (ETM) which converts each eight bits of data into 12 bits of data.

6. The recording apparatus as set forth in claim 1,
wherein the optical head records a record pattern combining a mark with a predetermined length and a space with a predetermined length.

7. The recording apparatus as set forth in claim 1, further comprising a pattern proportion calculator which detects a record pattern having a frequency of appearance equal to or lower than a predetermined threshold value relative to the entire record patterns, based on the random data reproduced by said optical head,
wherein said modulator further modulates random data which is generated by said random data generator and is not subjected to the exchange processing by said data exchange processor by the modulation method;
wherein said pattern proportion calculator detects the record pattern based on random data which is reproduced by said optical head and is not subjected to the exchange processing; and
wherein said data exchange processor performs exchange processing on the random data so as to increase the number of random data corresponding to the detected record pattern.

8. A record learning method for a recording apparatus configured to modulate record data by a predetermined modulation method and records record patterns corresponding to the record data on an optical disk, comprising:
generating random data as the record data;
performing exchange processing on the random data so as to equalize a frequency of appearance of each of the record patterns relative to the entire record patterns on the optical disk corresponding to the respective random data;
modulating the random data subjected to the exchange processing by the modulation method;
recording the record patterns corresponding to the modulated random data on the optical disk;
reproducing the modulated random data from the recorded record patterns; and
calculating correction amounts for recorded positions of the respective record patterns based on the reproduced random data.
